(19) United States
(12) Patent Application Publication
(10) Pub. No.: US 2022/0318030 A1
(43) Pub. Date: Oct. 6, 2022

(54) SETTINGS MANAGEMENT SYSTEM, SETTINGS MANAGEMENT METHOD, AND PROGRAM

(71) Applicant: PFU LIMITED, Ishikawa (JP)

(72) Inventors: Tetsuji HAGIWARA, Kanagawa (JP); Hitoshi HIGEUKON, Kanagawa (JP); Masahiro FURUYA, Kanagawa (JP)

(21) Appl. No.: 17/616,028

(22) PCT Filed: May 14, 2020
(86) PCT No.: PCT/JP2020/019208

§ 371 Date: Apr. 12, 2022

(30) Foreign Application Priority Data
Jun. 3, 2019 (JP) 2019-103478

(51) Int. Cl. G06F 9/445; G06K 15/02

(52) U.S. Cl. CPC G06F 9/44505; G06K 15/024

(57) ABSTRACT

A setting management system comprising: a carriage loaded with a device to be set; a setting terminal performing a setting operation on the devices to be set with which the carriage is loaded; and a management device managing the setting operation by the setting terminal. The setting terminal includes a first memory; and a first processor coupled to the first memory. The processor configured to: acquire device identification information for identifying each device to be set from the devices. The management device includes a second memory; and a second processor coupled to the second memory and the processor configured to: provide the setting terminal with setting information unique to each of the devices to be set in association with the acquired device identification information, and create a device ledger in which the acquired device identification information and the provided unique setting information are associated with each other.

### TECHNICAL FIELD

The present invention relates to a setting management system, a setting management method, and a program.

### BACKGROUND ART

For example, Patent Literature 1 discloses a computer terminal 2 including an individual information acquisition unit 21 that is connected to an information communication device 4 via a communication cable 5 and is capable of acquiring individual information individually allocated to the information communication device 4, a setting item display unit 22 that displays an item to be set selected from a plurality of setting items related to network information in an itemized state with respect to the individual information, a setting file generation unit 23 that is capable of generating a setting file in which input information input for the item to be set displayed on the setting item display unit 22 is associated with the individual information, and a setting file writing unit 24 that is capable of writing input information included in a setting file generated by the setting file generation unit 23 into an information communication device to be written identified from the individual information.

In addition, Patent Literature 2 discloses an operation management integrated node 19 that enables an operation manager to set each device in a common command format, converts the common format into a command for each device, inputs the command to each device, sets each device, and also checks consistency of a setting definition of the common format.

### CITATION LIST

### Patent Literature

Patent Literature 1: JP 2018-082240 A Patent Literature 2: JP 2005-197826 A

### SUMMARY OF THE INVENTION

### Technical Problems

An object is to provide a setting management system that makes setting operation of a device efficient,

### Solution To Problems

A setting management system according to the present invention includes a carriage that is loaded with a plurality of devices to be set, a setting terminal that performs a setting operation on the devices to be set with which the carriage is loaded, and a management device that manages the setting operation by the setting terminal, wherein the setting terminal includes an identification information acquisition unit that acquires device identification information for identifying each device to be set from the devices to be set with which the carriage is loaded, wherein the management device includes a setting information providing unit that provides the setting terminal with setting information unique to each of the devices to be set in association with the device identification information acquired by the identification information acquisition unit, and a ledger creation unit that creates a device ledger in which the device identification information acquired by the identification information acquisition unit and the unique setting information provided by the setting information providing unit are associated with each other.

Preferably, each of a plurality of the setting terminals further includes a setting operation unit that performs a setting operation on a plurality of devices to be set with which the carriage is loaded based on setting information provided from the setting information providing unit, wherein the management device or the setting terminal further includes a progress management unit that manages a progress of a setting operation by each of the setting terminals of a device to be set, and wherein the ledger creation unit settles the device ledger on condition that the setting operation is normally completed.

Preferably, the setting operation unit checks whether at least one version of setting information provided from the setting information providing unit and firmware of a device to be set is a predetermined version, and starts a setting operation on condition that the at least one version is the predetermined version.

Preferably, an input device that emulates an input by a keyboard or a console cable is installed in the carriage, and wherein the setting operation unit of the setting terminal inputs unique setting information to the devices to be set via the input device or the console cable, and erases the unique information from the management device or the setting terminal on condition that the setting operation is completed.

Preferably, the setting operation unit sequentially inputs setting information to the devices to be set according to a scenario via the input device or the console cable.

Preferably, the setting management system further includes a printing device, wherein the management device further includes a print data providing unit that, when the management device receives device identification information in association with the printing device, transmits, to the printing device, print data including information indicating a user or an installation place of each of the devices to be set based on the device identification information.

Preferably, the carriage is loaded with a plurality of devices to be set, wherein the setting terminal performs a setting operation on the devices to be set in parallel, and wherein the setting terminal includes a progress management unit that transmits, to the management device, a progress of a setting operation performed in parallel.

Preferably, the setting operation unit inputs setting information unique so each of the plurality of devices so be set via a USB cable or a console cable of the input device, and wherein the setting operation unit distributes a common data file received from the management device to the plurality of devices to be set via a LAN cable.

Preferably, an entire process for a device to be set includes at least an unpacking process of unpacking a device to be set from a package, a setting process of performing a setting operation on the unpacked device to be set, a label printing process of printing a label attached to the device to be set, and an inspection process of inspecting the device to be set for which the setting operation is completed, wherein the management device further includes a process management unit that manages a process of the device to be set with which each carriage is loaded in association with the device to be set and the carriage, wherein the setting operation unit starts a setting operation on condition that a preceding process for the setting process is completed by the process management unit, and wherein the ledger creation unit settles the device ledger on condition that all processes are normally completed by the process management unit.

Further, in a setting management method according to the present invention in a setting management system including a carriage that is loaded with a plurality of devices to be set, a setting terminal that performs a setting operation on the devices to be set with which the carriage is loaded, a management device that manages the setting operation by the setting terminal, a printing device that prints a label, and an inspection terminal that inputs an inspection result of the devices to be set, the method includes an identification information acquisition step of acquiring device identification information for identifying each device to be set from the devices to be set with which the carriage is loaded, a setting information providing step of the management device providing the setting terminal with setting information unique to each of the devices to be set in association with the acquired device identification information, a setting step of the setting terminal performing a setting operation on the devices to be set based on the provided setting information, a printing step of the printing device printing a label to be attached to a device to be set for which the setting operation is completed, and an inspection step of the inspection terminal receiving an input of an inspection result of a device to be set based on a label attached to the device to be set.

In addition, a program according to the present invention causes a computer to execute, in a computer system including a carriage that is loaded with a plurality of devices to be set, a setting terminal that performs a setting operation on the devices to be set with which the carriage is loaded, and a management device that manages the setting operation by the setting terminal, an identification information acquisition step of acquiring device identification information for identifying each device to be set from the devices to be set with which the carriage is loaded, a setting information providing step of providing the setting terminal with setting information unique to each of the devices to be set in association with the device identification information acquired by the identification information acquisition step, and a ledger creation step of creating a device ledger in which the device identification information acquired by the identification information acquisition step and the unique setting information provided by the setting information providing step are associated with each other.

### ADVANTAGEOUS EFFECTS OF INVENTION

The setting operation of the device can be made efficient.

### BRIEF DESCRIPTION OF DRAWINGS

FIG. 1 is a diagram illustrating an overall configuration of a setting management system 1.

FIG. 2 is a diagram illustrating a hardware configuration of a management server 2.

FIG. 3 is a diagram illustrating a functional configuration of the management server 2.

FIG. 4 is a diagram illustrating a relationship between a functional configuration of a setting terminal 3 and a device to be set 9 with which a carriage 4 is loaded.

FIG. 5 is a diagram illustrating the relationship between the functional configuration of a print control PC 50 and a printing device 52.

FIG. 6 is a flowchart describing an entire process in the setting management system 1.

FIG. 7 is a flowchart describing a setting operation process S30 in more detail.

FIG. 8 is a flowchart describing a label printing process S40 in more detail.

FIG. 9 is a flowchart describing a packing inspection process S50 in more detail.

### DESCRIPTION OF EMBODIMENT

Hereinafter, embodiment of the present invention will be described with reference to the drawings.

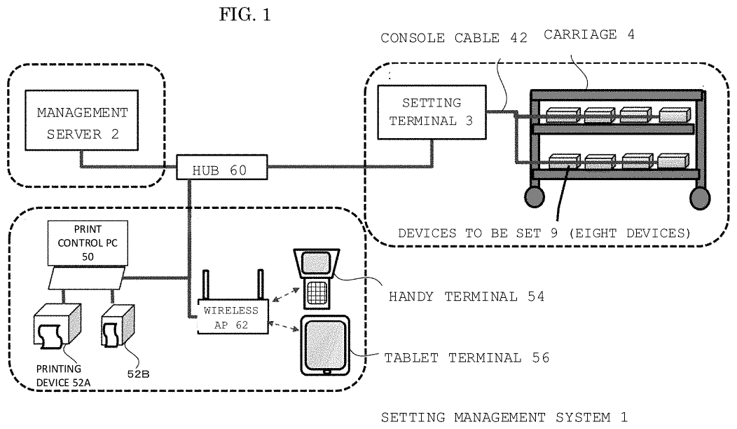

FIG. 1 is a diagram illustrating an overall configuration of a setting management system 1.

As illustrated in FIG. 1, the setting management system 1 includes a management server 2, a setting terminal 3, a carriage 4, a print control personal computer (print control PC) 50, a printing device 52, a handy terminal 54, and a tablet terminal 56, which are connected to each other via a network. The network includes, for example, a LAN cable, a hub 60, and a wireless access point (wireless AP) 62.

The management server 2 is a computer terminal on which a setting management program 22 (described later) operates. For example, the management server 2 manages the entire process including the setting operation by the setting terminal 3 and the printing operation by the printing device 52. The setting terminal 3 is a computer terminal, and performs the setting operation for the plurality of devices to be set 9 with which the carriage 4 is loaded in parallel according to an instruction from the management server 2.

The carriage 4 is a carriage which is loaded with the plurality of devices to be set 9. For example, the carriage 4 is a carriage with casters, and can be moved in a state where the carriage is loaded with the plurality of devices to be set 9. In the present example, the carriage 4 can be loaded with eight devices to be set 9, and moves to at least an unpacking place, a vicinity of the setting terminal 3, a vicinity of the printing device 52, an inspection place, and a packing place. A plurality of console cables 42 is prepared in the carriage 4. The setting terminal 3 is connected to the plurality of devices to be set 9 via the console cable 42.

The print control PC 50 is a computer terminal that controls print processing by the printing device 52, and causes the printing device 52 to execute the print process based on print data provided from the management server 2. In the present example, a printing device 52A prints a label to be attached to the outer box for packing the device to be set 9 according to the control of the print control PC 50. A printing device 52B prints a label to be attached to the housing of the device to be set 9 according to the control of the print control PC 50.

The handy terminal 54 is a portable computer terminal that inputs identification information (manufacturing machine number) of the device to be set 9. For example, the handy terminal 54 reads the manufacturing machine number of the device to be set 9 in the incoming process, the unpacking/allocation process, the printing process, the inspection process, and the packaging process. The tablet terminal 56 is a tablet computer terminal that inputs a result of an inspection performed by an inspection person in an inspection process of inspecting the device to be set 9.

The setting management system 1 is effective, for example, when a large-scale network device setting operation with a short delivery period occurs and a large amount of setting operation in a short period of time (for example, several thousands to several tens of thousands of vehicles in 2 to 5 months) is performed. As a method for mass-producing the same product, a line production method is known. In the line production method, since processing is performed while flowing the object to be processed with a belt conveyor or the like, it is not suitable for individual correspondence. Specifically, in the setting operation of the network device or the computer, there are various types of setting information and it is difficult to distinguish the setting information from the appearance, and thus it is difficult to take an individual response in the flow operation.

In addition, in the setting operation of the network device so far, it is necessary to connect the network device and the setting terminal one by one, and it is necessary to prepare a considerable number of setting terminals in order to develop the network device and the setting terminal in large quantities. For the purpose of reducing the operation space and the facility preparation cost in order to perform the operation, whether the setting operation on a plurality of network device can be simultaneously performed from one setting terminal has been examined. In addition, for the short-term development, it is necessary to grasp the operation progress in real time and to perform accurate control, and it is necessary to have a mechanism capable of grasping the progress state of each process in conjunction with the operation plan.

Further, in order to simultaneously perform setting operation on a plurality of setting terminals from one setting terminal, there are the following problems. Since it is a console connection, there is no physical port for multiple connection. At the time of connection of a plurality of devices, it is necessary to monitor and control each setting status. It is necessary to manually set individual identification (manually input an operation number). In addition, in order to grasp and control the operation progress of each process from arrival to shipment, there are the following problems. Since the operation progress is controlled for each process, it is necessary to grasp the entire operation progress in conjunction with each process. Since the progress state is checked manually, a time lag from the actual state occurs, and it is difficult to grasp the situation in real time.

Therefore, in the setting management system 1 of the present embodiment, the following handling is used for the method of one-to-many connection and the method of controlling simultaneous connection of a plurality of devices. The console cable 42 connects the setting terminal 3 and the device to be set 9 (network device) using a USB console cable.

In the console cable 42, the hub is used to connect up to 8 ports of the USB console cable to one setting terminal 3. One carriage 4 is loaded with all eight devices to be set 9 (network devices).

The setting terminal 3 individually identifies and controls each USB-connected console cable 42. The setting terminal 3 acquires a manufacturing machine number from an output code from the device to be set 9 (network device) and performs individual identification.

In order to grasp the progress state of each process, the management server 2 assigns a process ID (identification information for identifying a process) to each device, and automatically receives process ID information from each process at the time of process change.

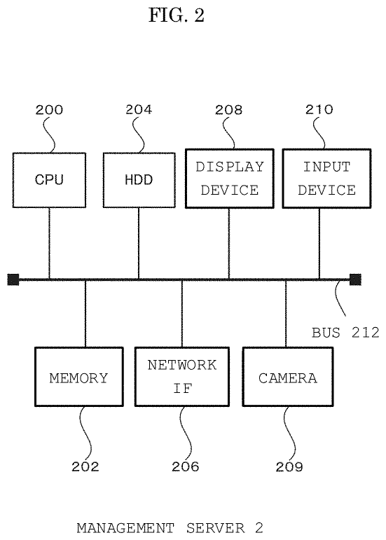

FIG. 2 is a diagram illustrating a hardware configuration of the management server 2.

As illustrated in FIG. 2, the management server 2 includes a CPU 200, a memory 202, an HDD 204, a network interface 206 (network IF 206), a display device 208, and an input device 210, and these components are connected to each other via a path 212.

The CPU 200 is, for example, a central processing unit.

The memory 202 is, for example, a volatile memory, and functions as a main storage device.

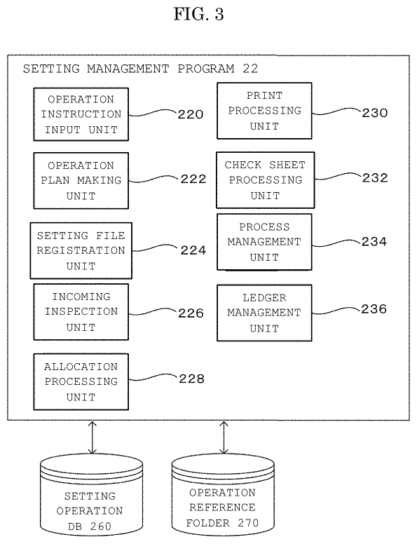

The HDD 204 is, for example, a hard disk drive device to store a computer program (for example, the setting management program 22 in FIG. 3) and other data files as a nonvolatile recording device.

The network IF 206 is an interface for wired or wireless communication.

The display device 208 is, for example, a liquid crystal display.

The input device 210 is, for example, a mouse and a keyboard touch panel.

FIG. 3 is a diagram illustrating a functional configuration of the management server 2.

As illustrated in FIG. 3, the setting management program 22 is installed in the management server 2, and a setting operation database 260 (setting operation DB 260) and an operation reference folder 270 are configured. The setting management program 22 is stored in a recording medium such as a CO-ROM, for example, and is installed in the management server 2 via the recording medium.

Part or all of the setting management program 22 may be realized by hardware such as an ASIC, or may be realized by using part of a function of an operating system (OS).

The setting operation DB 260 stores setting information of each of the devices to be set 9 and a ledger of the device to be set 9.

The operation reference folder 270 is a folder to which the setting terminal 3, the print control PC 50, and the like can refer, and a data file necessary for the setting operation and the like is placed therein.

The setting management program 22 includes an operation instruction input unit 220, an operation plan making unit 222, a setting file registration unit 224, an incoming inspection unit 226, an allocation processing unit 228, a print processing unit 230, a check sheet processing unit 232, a process management unit 234, and a ledger management unit 236.

In the setting management program 22, the operation instruction input unit 220 takes in setting information from the customer and registers the setting information in the setting operation DB 260.

The operation plan making unit 222 makes a mass production plan for the setting operation and registers the mass production plan in the setting operation DB 260.

The setting file registration unit 224 takes in the update date and the file size of the setting file registered is the setting operation DB 260 to store the registered setting file (setting file provided from the customer) in the operation reference folder 270.

The incoming inspection unit 226 inputs a result of the incoming inspection of the incoming device to be set 9 (network device). Specifically, the incoming inspection unit 226 acquires a manufacturing machine number (device identification information) of the device to be set 9 via the handy terminal 54, and registers the acquired manufacturing machine number in the device ledger. The incoming inspection unit 226 is an example of an identification information acquisition unit according to the present invention.

The allocation processing unit 228 allocates the device to be set 9 for which incoming inspection has been completed to the provided setting file. Specifically, the allocation processing unit 228 allocates the setting file which the model matches each device to be set 9 in order of completion of the incoming inspection, and associates the manufacturing machine number of each device ledger with the setting file. Note that a combination of the setting file registration unit 224 and the allocation processing unit 228 is an example of a setting information providing unit according to the present invention.

Upon receiving the device identification information (specifically, a manufacturing machine number) in association with the printing device 52, the print processing unit 230 transmits print data including information indicating the user or the installation place of each of the device to be set 9 to the printing device 52 based on the device identification information. The print processing unit 230 is an example of a print data providing unit according to the present invention. Specifically, the print processing unit 230 transmits, to the printing device 52A, the print data of the outer box label on which the individual identification information associated with the manufacturing machine number is displayed, and transmits, to the printing device 52B, the print data of the device housing label on which the individual identification information associated with the manufacturing machine number is displayed.

Upon receiving the device identification information (specifically a manufacturing machine number), the check sheet processing unit 232 reads an electronic check sheen for performing inspection of the device to be set 9 for which the setting operation has been completed based on the received device identification information to transmit the read electronic check sheet to a tablet terminal 56.

The process management unit 234 manages the process of each device to be set 9 based on the process ID. The process ID is updated every time the process is completed.

The ledger management unit 236 creates a device ledger in which the device identification information acquired by the handy terminal 54 and the unique setting file allocated by the allocation processing unit 228 are associated with each other. More specifically, the ledger management unit 236 creates and updates a device ledger in which the manufacturing machine number of the device to be set 9 acquired by the handy terminal 54, the unique setting file allocated to the device to be set 9 by the allocation processing unit 228, and the process ID of the device to be set 9 are associated with each other. The device ledger is settled as a ledger when all processes are completed.

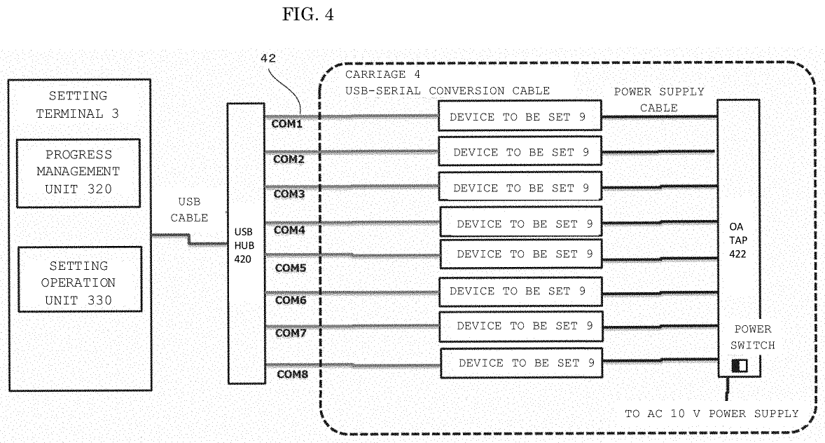

FIG. 4 is a diagram illustrating a relationship between the functional configuration of the setting terminal 3 and the device to be set 9 with which the carriage 4 is loaded.

As illustrated in FIG. 4, the setting terminal 3 includes a progress management unit 320 that manages the progress of the setting operation of the device to be set 9 (network device) and a setting operation unit 330 that performs the setting operation of the device to be set 9.

The progress management unit 320 manages and displays the progress of the setting operation for the plurality of devices to be set 9 connected via a hub 420 and the console cables 42.

The setting operation unit 330 sequentially inputs individual setting information in parallel according to the scenario to each of the plurality of devices to be set 9 connected via the USB hub 420 and the console cables 42. The scenario includes an order of information to be input and a waiting time after input.

The carriage 4 is provided with an GA tap 422, and supplies power to the plurality of devices to be set 9 via a power supply cable.

The console cable 42 is specifically a USB-serial conversion cable.

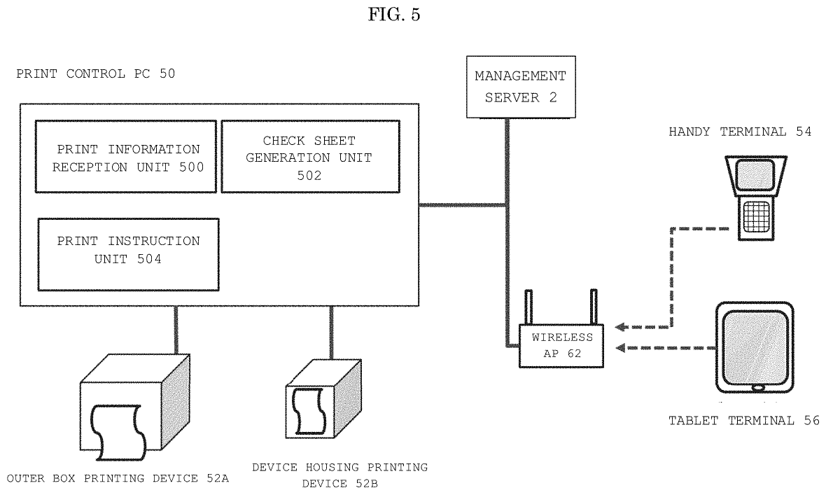

FIG. 5 is a diagram illustrating the relationship between the functional configuration of the print control PC 50 and the printing device 52.

As shown in FIG. 5, the print control PC 50 includes a print information reception unit 500 that receives print data transmitted from the handy terminal 54 via the web application of the management server 2, a print instruction unit 504 that controls the printing device 52 to perform printing according to the received print data, and a check sheet generation unit 502 that generates an electronic check sheet.

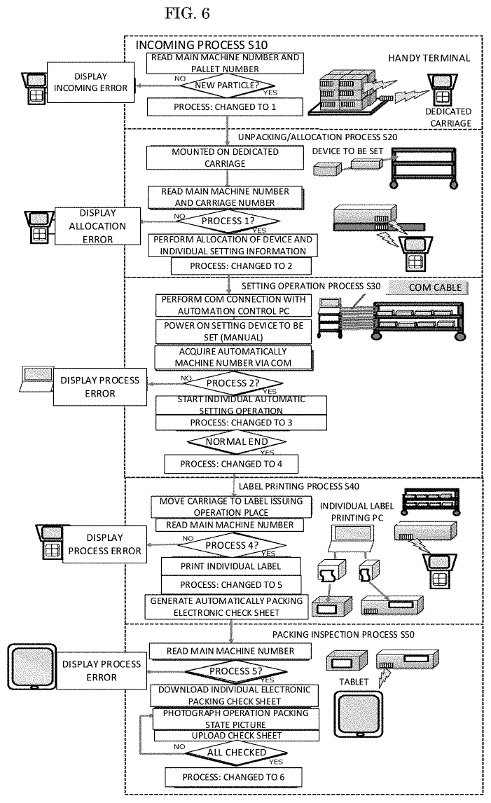

FIG. 6 is a flowchart describing an entire process in the setting management system 1. As shown in FIG. 6, the entire process includes an incoming process S10, an unpacking/allocation process S20, a setting operation process S30, a label printing process S40, and a packing inspection process S50. For example, the unpacking/allocation process S20, the setting operation process S30, the label printing process S40, and the packing inspection process S50 are performed at different places, and these processes are performed by moving the carriage 4.

In the incoming process S10, when the device to be set 9 arrives, a manufacturing machine number and a pallet number of the device to be set 9 are acquired using the handy terminal 54 and transmitted to the management server 2. The incoming inspection unit 226 of the management server 2 stores the device information (manufacturing machine number) received from the handy terminal 54 in the device ledger in the setting operation DB 260 as a device list, and at the same time, the process management unit 234 records the process ID as “1”. When the already registered manufacturing machine number is read, the incoming inspection unit 226 displays an incoming error on the screen of the handy terminal 54.

In the unpacking/allocation process S20, the device to be set 9 to perform the setting operation is unpacked, mounted on the carriage 4, and the dedicated carriage barcode and the manufacturing machine number of the mounted device are read by the handy terminal 54 to confirm that the target manufacturing machine number is subjected to the incoming process by the present system and the process ID is “1”. When there is no problem, the allocation processing unit 228 of the management server 2 allocates the setting file to the manufacturing machine number of the read device to be set 9, and the process management unit 234 changes the process ID of the target machine to “2”. When the process ID is not “1”, an allocation error is displayed on the screen of the handy terminal 54.

In the setting operation process S30, the device to be set 9 with which the carriage 4 is loaded is connected to the setting terminal 3 via the console cable 42. When the power of the device to be set 9 is turned on, the setting terminal 3 acquires the manufacturing machine number of the device to be set 9 via the console cable 42, confirms that the process ID is “2”, and starts individual automatic setting of the device based on the individual setting information allocated to the manufacturing machine number when there is no problem. When the process ID is not “2”, a process error is displayed on the progress screen of the setting terminal 3. When notified of the start of the automatic setting from the setting terminal 3, the management server 2 (process management unit 234) changes the process ID to “3” at the start of the automatic setting, and changes the process ID to “4” at the normal end of the automatic setting.

In the label printing process 840, the printing device 52B prints a device housing label as an individual identification label on the device to be set 9 for which the setting operation 830 has been completed, and the printing device 52A prints an outer box label and these labels are attached. Specifically, the handy terminal 54 reads the manufacturing machine number of the device to be set 9, and confirms that the process ID of the target device is “4”. When there is no problem, the print processing unit 230 of the management server 2 provides the printing device 52A and the printing device 52B with the print data of the label in which the individual identification information associated with the manufacturing machine number is described in the setting operation DB 260, and one label for each is printed. When the process ID is not “4”, a process error is displayed on the screen of the handy terminal 54. After printing, the check sheet generation unit 502 generates data of an electronic check sheet to be used in the next process and makes the data downloadable, and the management server 2 (process management unit 234) changes the process ID of the device to be set 9 to “5”.

In the packing inspection process S50, the device to be set 9 to which the label is attached is moved to the packing operation place to perform the packing operation. The manufacturing machine number of the device to be set 9 is read by the tablet terminal 56, it is confirmed that the process ID of the device to be set 9 is “5”, and when there is no problem, the check sheet generation unit 502 downloads the electronic check sheet generated in the preceding process from the management server 2. According to the procedure described in the electronic check sheet, the package is checked, the state of the final packing state, and the attached label are photographed by the camera of the tablet terminal 56, evidence is acquired, and after the operation is completed, the process of uploading to the management server 2 is performed. At this time, the check sheet generation unit 502 checks whether all the items are checked with check marks, and in a case where there is an item without a check mark, the setting is such that the sheet cannot be uploaded. After the upload is completed, the process management unit 234 changes the process ID of the device to be set 9 to “6”.

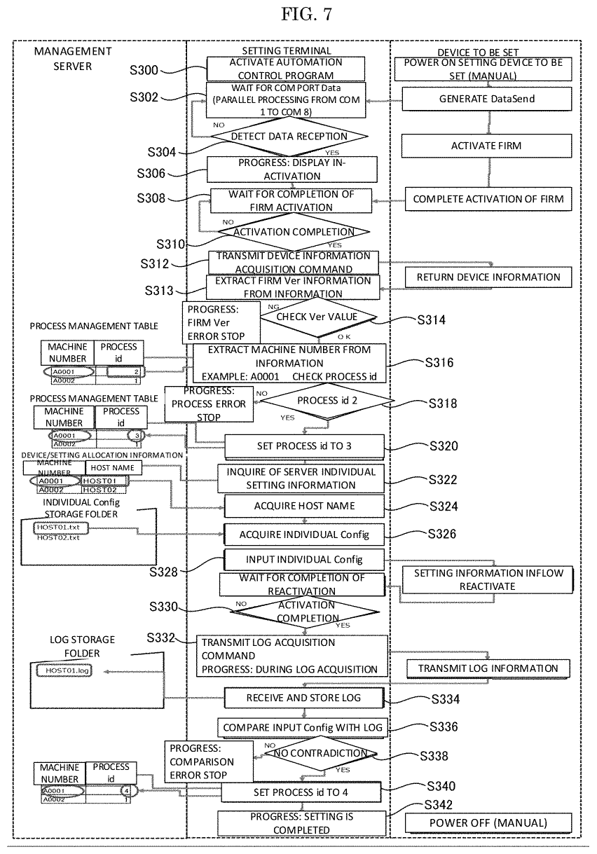

FIG. 7 is a flowchart describing the setting operation process 530 in more detail.

As illustrated in FIG. 7, when the setting operation unit 330 (the automation control program in the drawing) is activated on the setting terminal 3 (S300), reception of data from the COM port to which the console cable 42 is connected is waited (S302).

When the device to be set 9 is powered on, data transmission is started via the COM port. When detecting the data reception (S304: Yes), the setting operation unit 330 (automation control program) sets the progress display of the target COM port to “activating” (S306) and waits for the firmware of the device to be set 9 to be activated (S308).

When the activation of the firmware is confirmed by receiving the specific character string (S310: Yes), the setting operation unit 330 transmits a device information acquisition command to the device to be set 9 (S312), and receives the device information from the device to be set 9. The device information includes a manufacturing machine number, and the setting operation unit 330 in this case is an example of an identification information acquisition unit according to the present invention.

The setting operation unit 330 extracts version information of the firmware from the received device information (S313), checks whether there is a problem in the version (S314), and displays a firmware version error on the progress management unit 320 to stop the setting operation when there is a problem in the version. When there is no problem in the version, the manufacturing machine number is extracted from the acquired device information (S316), and it is confirmed that the process ID of the device to be set 9 for the manufacturing machine number is “2” (S318). When there is no problem, the process ID is changed to “3” (S320), the device/setting allocation information of the management server 2 is referred to (S322), and an individual setting value (host name) is acquired (S324). When the process ID is not “2” a process error is displayed on the progress screen of the setting terminal 3, and the operation is stopped.

The setting operation unit 330 acquires an individual setting file corresponding to the acquired host name from the operation reference folder 270 of the management server 2 (S326), and inputs individual setting information to the device to be set 9 via the COM port (S328). The setting terminal 3 waits for the reactivation of the device to be set 9 after the input of the individual setting information, and after completion of the reactivation (S330: Yes), the setting terminal 3 transmits a log acquisition command to the device to be set 9 via the COM port (S332). The setting terminal 3 stores the log transmitted from the device to be set 9 in the device ledger of the management server 2 (S334). The setting terminal 3 compares the input individual setting information with the log file acquired after the setting, and checks whether there is a contradiction in the setting contents (S336). When there is no problem (3338: Yes), the process ID of the device to be set is changed to “4” (3340), and the progress management unit 320 displays “setting completed” in the progress display (3342). The operator turns off the power of the device to be set 9, and the setting operation is completed. When there is a contradiction in the setting contents, a comparison error is displayed on the progress screen of the setting terminal 3, and the operation is stopped.

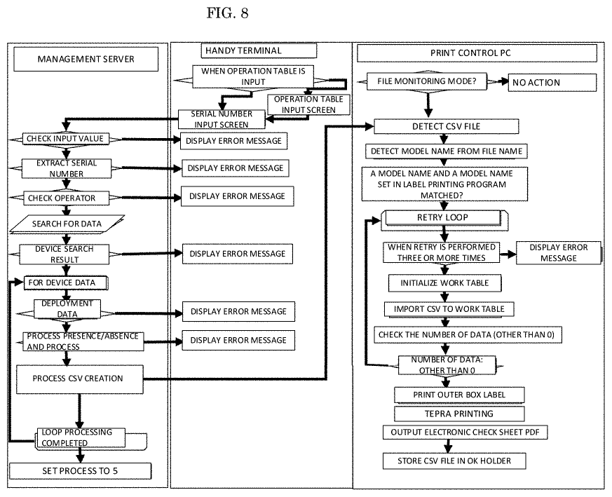

FIG. 8 is a flowchart describing the label printing process S40 in more detail

As illustrated in FIG. 8, the input state of the carriage 4 is confirmed by the handy terminal 54, and when there is no problem, the manufacturing machine number is input on the input screen of the manufacturing machine number. When the identification information of the carriage 4 is not input, an input screen of the operation table identification information is displayed, and an input screen of the manufacturing machine number is displayed after the input.

After inputting the manufacturing machine number, the management server 2 performs an input value check, extraction of the manufacturing machine number, and an operator check to search for data. The process ID is confirmed from the retrieved development data, a CSV file including an item to be printed is created, and the process management unit 234 changes the process ID of the device to be set 9 to “5”.

The print control PC 50 detects the CSV file, detects a model name from the file name, checks whether the model name matches the model name set in the print instruction unit 504, imports the CSV file to the worktable, and checks the number of data.

In a case where the number of data is 0, the print control PC 50 performs import of the CSV three times, and displays an error message in a case where the number of times is three or more.

When the number of data items is other than 0, the print control PC 50 causes the printing device 52A and the printing device 52B to print the outer box label and the device housing label, outputs the electronic check sheet as a PDF file to store the imported CSV file in the OK folder.

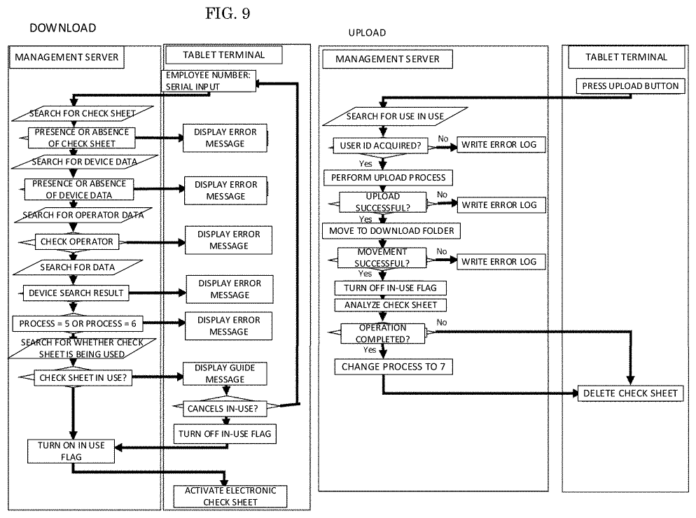

FIG. 9 is a flowchart describing the packing inspection process S50 in more detail.

As illustrated in FIG. 9, in a scene of downloading the electronic check sheet, the employee number and the manufacturing machine number are input to the tablet terminal 56. The management server 2 searches the electronic check sheet from the input employee number and the manufacturing machine number, and checks the presence or absence of the electronic check sheet. When there is no electronic check sheet, an error message is displayed.

When there is a check sheet, device data is searched from the input manufacturing machine number, and the presence or absence thereof is checked. When there is no device data, an error message is displayed.

When there is the device data, the operator data is searched for from the input employee number. When there is no operator data, an error message is displayed.

When there is the operator data, the device data is searched for, and The process ID of the device to be set 9 is changed to “6”.

Whether the check sheet is being used is searched, and when the check sheet is being used, a guidance message is displayed. When the electronic check sheet can be used, the tablet terminal 56 downloads the target electronic check sheet from the management server 2

In a scene of uploading the electronic check sheet, after the checking operation by the electronic check sheet is completed, the user presses the “upload” button on the tablet terminal 56. The tablet terminal 56 searches for a user who is using, acquires a user ID, and performs an electronic check sheet upload process for the management server 2. When the user ID cannot be acquired, an error log is output and the process is stopped.

The check sheet processing unit 232 of the management server 2 confirms that the electronic check sheet has been successfully uploaded, and when there is no problem, the file is moved to the download folder, so that the file can be downloaded in the checked state. When the upload failure or the movement failure to the download folder occurs, the check sheet processing unit 232 outputs an error log and is stopped. The checking status of the electronic check sheet whose movement has been completed is analyzed, and when all completed, the process management unit 234 changes the process ID to “7”. The tablet terminal 56 deletes the electronic check sheet data on the tablet terminal 56.

As described above, according to the setting management system 1 of the present embodiment, it is possible to simultaneously set settings of a plurality of network devices. Further, it is possible to compress the operation space by mounting all the setting terminal 3 and the devices to be set 9 on the carriage 4.

In addition, according to the setting management system 1, the administrator can grasp in real time how many devices are operating in which process.

### REFERENCE SIGNS LIST

1 setting management system
2 management server
3 setting terminal
4 carriage
52 printing device
54 handy terminal
56 tablet terminal

1. A setting management system comprising:
a carriage that is loaded with a device to be set;
a setting terminal that performs a setting operation on the devices to be set with which the carriage is loaded; and
a management device that manages the setting operation by the setting terminal; wherein
the setting terminal includes
a first memory; and
a first processor coupled to the first memory and the first processor configured to:
acquire device identification information For identifying each device to be set from the devices to be set with which the carriage is loaded; wherein
the management device includes
a second memory; and
a second processor coupled to the second memory and the second processor configured to:
provide the setting terminal with setting information unique to each of the devices to be set in association with the acquired device identification information, and
create a device ledger in which the acquired device identification information and the provided. unique setting information are associated with each other.

2. The setting management system according to claim comprising a plurality of the setting terminals; and wherein the first processor of each of the setting terminals is further configured to:
perform the setting operation on the plurality of devices to be set with which the carriage is loaded based on the provided setting information; and wherein the second processor or the first processor of each of the setting terminals as further configured to:
manage a progress of the setting operation of the devices to be set, by each of the setting terminals; and wherein the second processor is configured to settle the device ledger on condition that the setting operation is normally completed.

3. The setting management system according to claim 2, wherein the first processor is further configured to:
check whether a version of at least one of the provided setting information or firmware of a device to be set is a predetermined version; and start a setting operation on condition that the version of at least one of the provided setting information or firmware of a device to be set is the predetermined version,

4. The setting management system according to claim 3, wherein
an input device that emulates an input by a keyboard or a console cable is installed in the carriage; and
the first processor is further configured to:
input unique setting information to the devices to be set via the input device or the console cable, and erase the unique information from the management device or a plurality of the setting terminals on condition that the setting operation is completed.

5. The setting management system according to claim 4, wherein the first processor is further configured to:
sequentially input setting information to the devices to be set according to a scenario via the input device or the console cable.

6. The setting management system according to claim 5, further comprising:
a printing device; and
the second processor is further configured to:
receive device identification information in association with the printing device; and
transmit, to the printing device, print data including information indicating a user or an installation place of each of the devices to be set based on the device identification information, when receiving the device identification information.

7. The setting management system according to claim 1, wherein
the carriage is loaded with a plurality of devices to be set; and the first processor is further configured to:
perform a setting operation on the devices to be set in parallel; and
transmit, to the management device, a progress of a setting operation performed in parallel.

8. The setting management system according to claim 4, wherein the first processor is further configured to:
input the setting information unique to each of the plurality of devices to be set via a USB cable or a console cable of the input device, and
distribute a common data file received from the management device to the plurality of devices to be set via a LAN cable.

9. The setting management system according to claim 2, wherein
an entire process for a device to be set includes at least an unpacking process of unpacking a device to be set from a package, a setting process of performing a setting operation on the unpacked device to be set, a label printing process of printing a label attached to the device to be set, and an inspection process of inspecting the device to be set for which the setting operation is completed;
the second processor is further configured to:
manage a process of the device to be set with which each carriage is loaded in association with the device to be set and the carriage;
start the setting operation on condition that a preceding process for the setting process is completed; and
settle the device ledger on condition that all processes are normally completed.

10. A setting management method in a setting management system including a carriage that is loaded with a plurality of devices to be set, a setting terminal that performs a setting operation on the devices to be set with which the carriage is loaded, a management device that manages the setting operation by the setting terminal, a printing device that prints a label, and an inspection terminal that inputs as inspection result of the devices to be set;
wherein the method comprising the steps of:
acquiring device identification information for identifying each device to be set from the devices to be set with which the carriage is loaded;
providing the setting information unique to each of the devices to be set in association with the acquired device identification information;
performing a setting operation on the devices to be set based on the provided setting information;
printing a label to be attached to a device to be set for which the setting operation is completed; and
receiving an input of an inspection result of the device to be set based on the label attached to the device to be set.

11. The setting management method according to claim 10, wherein
the carriage that is loaded with the devices to be set is moved before and after the setting step, before and after the printing step, and before and after the inspection step.

12. A non-transitory computer-readable recording medium storing thereon a computer program that causes a computer to perform, in a computer system including a carriage that is loaded with a plurality of devices to be set, a setting terminal that performs a setting operation on the devices to be set with which the carriage is loaded, and a management device that manages the setting operation by the setting terminal; wherein
the program causes a computer to perform a method comprising:
acquiring device identification information for identifying each device to be set from the devices to be set with which the carriage is loaded;
providing the setting terminal with setting information unique to each of the devices to be set in association with the acquired device identification information; and
creating a device ledger in which the acquired device identification information and the provided unique setting information are associated with each other.
